(19) United States
(12) Patent Application Publication
(10) Pub. No.: US 2011/0279050 A1
(43) Pub. Date: Nov. 17, 2011

(54) LIGHTING DEVICE FOR DISPLAY DEVICE, DISPLAY DEVICE, AND TELEVISION RECEIVER

(75) Inventor: Yasumori Kuromizu, Osaka-shi (JP)

(73) Assignee: SHARP KABUSHIKI KAISHA, Osaka-shi, Osaka (JP)

(21) Appl. No.: 13/145,567

(22) PCT Filed: Nov. 10, 2009
(86) PCT No.: PCT/JP2009/069100

§ 371 Date: Jul. 21, 2011

(30) Foreign Application Priority Data
Feb. 12, 2009 (JP) 2009-029981

(51) Int. Cl. H01J 17/49; H05B 41/14

(52) U.S. Cl. 315/228

(57) ABSTRACT

A lighting device 12 includes: discharge tubes 17; a support member 151 supporting the discharge tubes 17; connecting terminals 152 arranged on the support member 151, the connecting terminals 152 holding the discharge tubes 17 and configured to function as terminals to supply drive power; and balancing components 56 configured to balance currents to be fed to the connecting terminals 152. The balancing components 56 are disposed adjacent to the respective connecting terminals 152 in an area on the support member 151. The area is closer to the center in the arrangement direction than outermost one of the connecting terminals 152. Two of the balancing components 56 are disposed in at least one of areas. Each of the areas is between adjacent two of the connecting terminals 152 in the array. The two of the balancing components 56 correspond to the two of the connecting terminals 152.

### TECHNICAL FIELD

The present invention relates to a lighting device for a display device, a display device, and a television receiver.

### BACKGROUND ART

A liquid crystal display device is a typical one of display devices with non-light-emitting optical elements. The display device includes a display panel, such as a liquid panel, and a backlight unit for emitting light to the display panel. The backlight unit is disposed behind the display panel (for example, see Patent Document 1).
Patent Document 1: Japanese Unexamined Patent Application Publication No. 2006-19260

### PROBLEM TO BE SOLVED BY THE INVENTION

The backlight unit disclosed in Patent Document 1 includes a configuration for parallel driving CCFLs. Specifically, Document 1 discloses a configuration including a plurality of cold cathode lamps, capacitors, and an inverter circuit. The cold cathode lamps are connected in parallel to each other. The capacitors are connected to the respective ends of the respective cold cathode lamps and equalize currents fed to the respective connecting terminals. The inverter circuit is connected to the capacitors and supplies drive power to the cold cathode lamps. With this configuration, the CCFLs can be parallel driven, and a uniform brightness can be provided. However, Document 1 does not disclose the positions of the capacitors relative to the respective cold cathode lamps. Document 1 merely discloses the configuration in which the capacitors are connected to the ends of the cold cathode tubes.

### DISCLOSURE OF THE PRESENT INVENTION

An object of the present invention is to provide a lighting device for a display device with a narrower frame of the display device. Another object of the present invention is to provide a display device with such a lighting device for a display device. Still another object of the present invention is to provide a television receiver with such a display device.

### MEANS FOR SOLVING THE PROBLEM

In order to solve the problem, a lighting device for a display device includes: a plurality of discharge tubes disposed adjacent to each other in parallel arrangement at predetermined intervals; a power source configured to supply drive power for parallel driving the discharge tubes; a support member supporting ends of the discharge tubes; a plurality of connecting terminals arranged on the support member so as to make an array extending in an arrangement direction in which the discharge tubes are disposed, the connecting terminals holding the discharge tubes individually and configured to function as terminals to supply the drive power to the respective discharge tubes; and a plurality of balancing components configured to balance currents of the drive power to be fed to the connecting terminals, the balancing components being connected between the power source and the respective connecting terminals. The plurality of balancing components is disposed adjacent to the respective connecting terminals in an area on the support member. The area is closer to the center in the arrangement direction than outermost one of the connecting terminals in the arrangement direction. Two of the balancing components are disposed in at least one of areas on the support member. Each of the areas is between two of the adjacent connecting terminals in the array. The two of the balancing components correspond to the two of the connecting terminals defining the at least one area.

The balancing components of the lighting device for a display device balance the currents of the drive power to be fed to the respective connecting terminals. Because of this, the currents fed to the respective discharge tubes can be balanced (evened). Therefore, the common power source can parallel drive the plurality of discharge tubes.

Furthermore, the plurality of balancing components are disposed adjacent to the respective connecting terminals in an area on the same support member. The area is closer to the center in the arrangement direction than outermost one of the connecting terminals in the arrangement direction. In comparison to this, another configuration can be considered such that a balancing component is disposed still outer than outermost one of connecting terminals in the arrangement direction of the discharge tubes. When being compared to this configuration, the configuration of the present invention can provide a narrower frame area, which is a non-illumination area of the lighting device for a display device. Therefore, a frame area of the display device can be narrower.

Furthermore, two of the balancing components are disposed in at least one of areas on the support member. Each of the areas is between adjacent two of the connecting terminals in the array. The two of the balancing components correspond to the two of the connecting terminals. Because of this, the following configuration is possible. In the configuration, no balancing component is disposed between connecting terminals in an area on the support member. The area is closer to the center in the arrangement direction of the discharge tubes.

### BRIEF DESCRIPTION OF THE DRAWINGS

FIG. 1 is an exploded perspective view illustrating a schematic configuration of a television receiver;

FIG. 2 is an exploded perspective view illustrating a schematic configuration of a liquid crystal display device (a display device);

FIG. 3 is a sectional view along line A-A in FIG. 2;

FIG. 4 is a front view illustrating a main configuration of a backlight unit (a lighting device for a display device);

FIG. 5 is a front view illustrating a position of a frame in the backlight unit;

FIG. 6 is a back view illustrating a main configuration of the backlight unit;

FIG. 7 is a perspective view illustrating a configuration of a light-source holder;

FIG. 8 is an explanatory diagram illustrating a configuration for supplying drive power to cold cathode tubes;

FIG. 9 is an explanatory view schematically illustrating a configuration related to power supply;

FIG. 10 is a perspective view illustrating a configuration of a clip terminal;

FIG. 11 is a perspective view illustrating a configuration of one of the cold cathode tubes;

FIG. 12 is a plan view illustrating a configuration of a ferrule of the cold cathode tube;

FIG. 13 is a front view illustrating a state in which the clip terminal holds the cold cathode tube;

FIG. 14 is a plan view illustrating the state in which the clip terminal holds the cold cathode tube;

FIG. 15 is a perspective view illustrating a modification of the ferrule;

FIG. 16 is an explanatory view illustrating a configuration for insulating the clip terminal from the chassis;

FIG. 17 is an explanatory view illustrating a configuration for insulating the clip terminal from the chassis; and

FIG. 18 is a front view illustrating a modification of the backlight device.

### BEST MODE FOR CARRYING OUT THE INVENTION

An embodiment according to the present invention will be described with reference to the drawings.

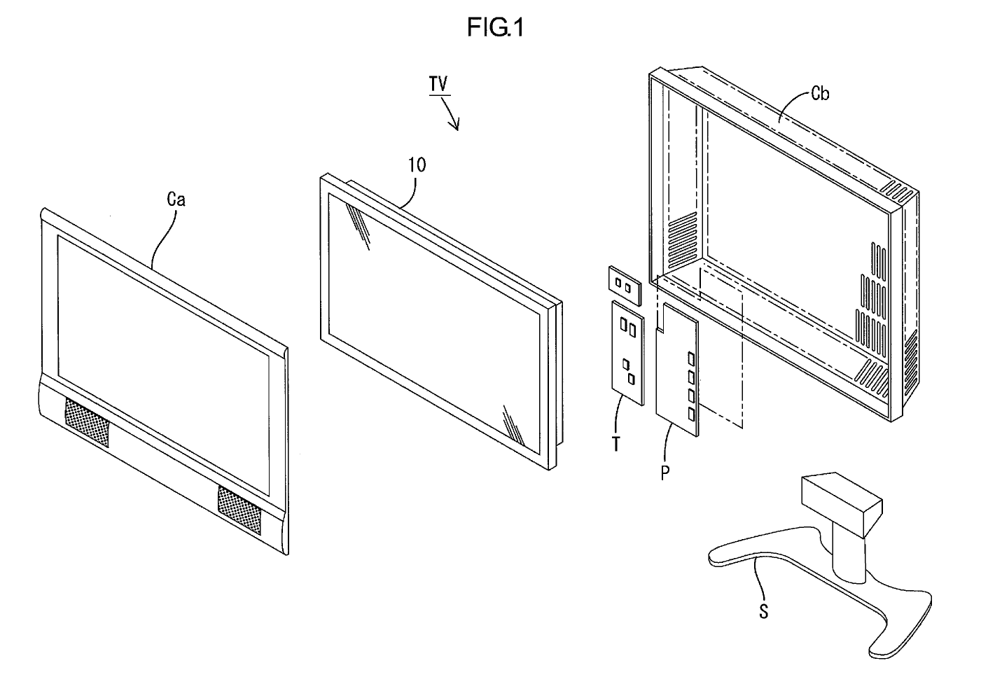

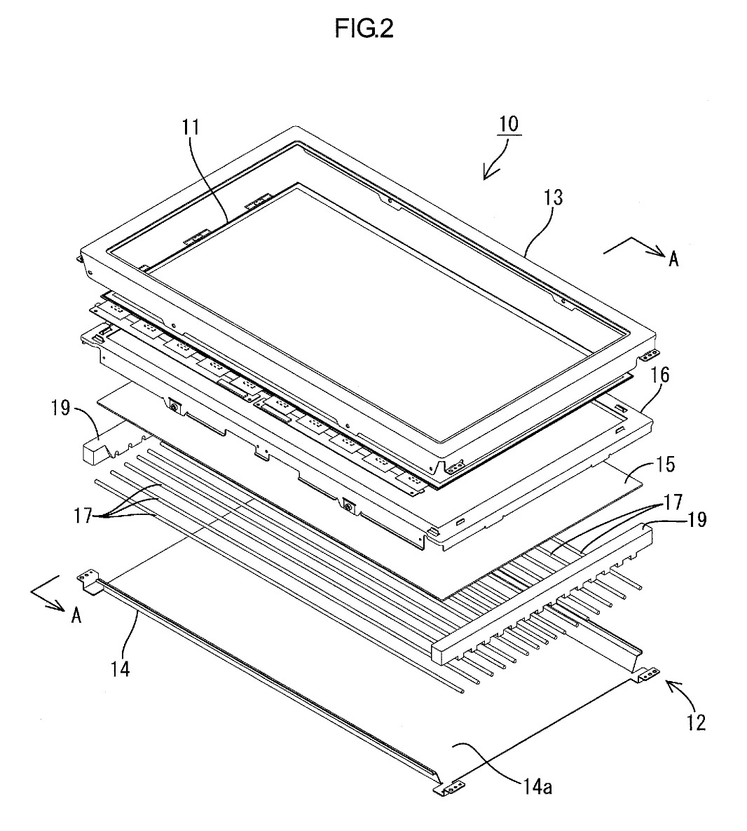

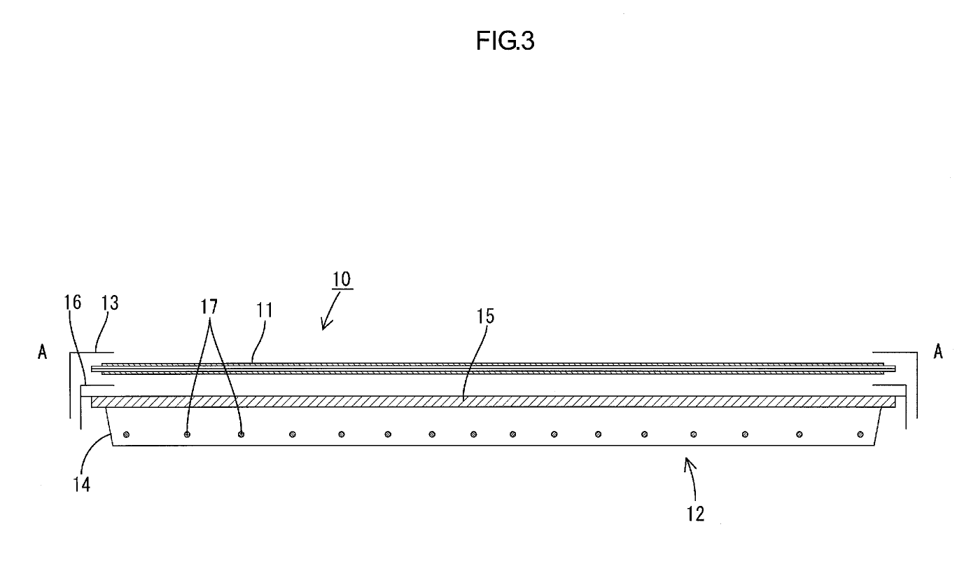

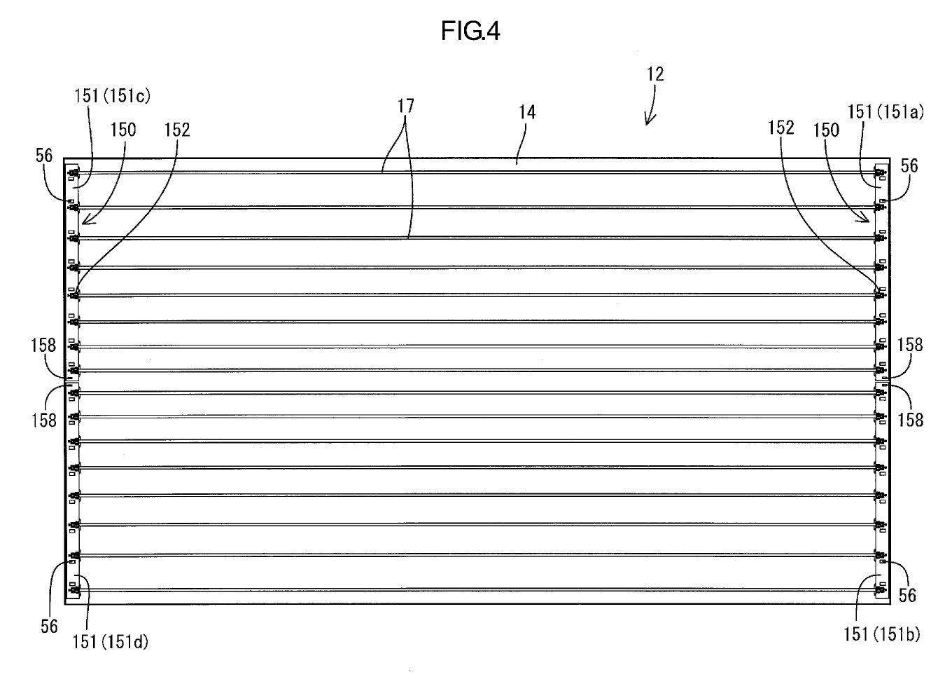

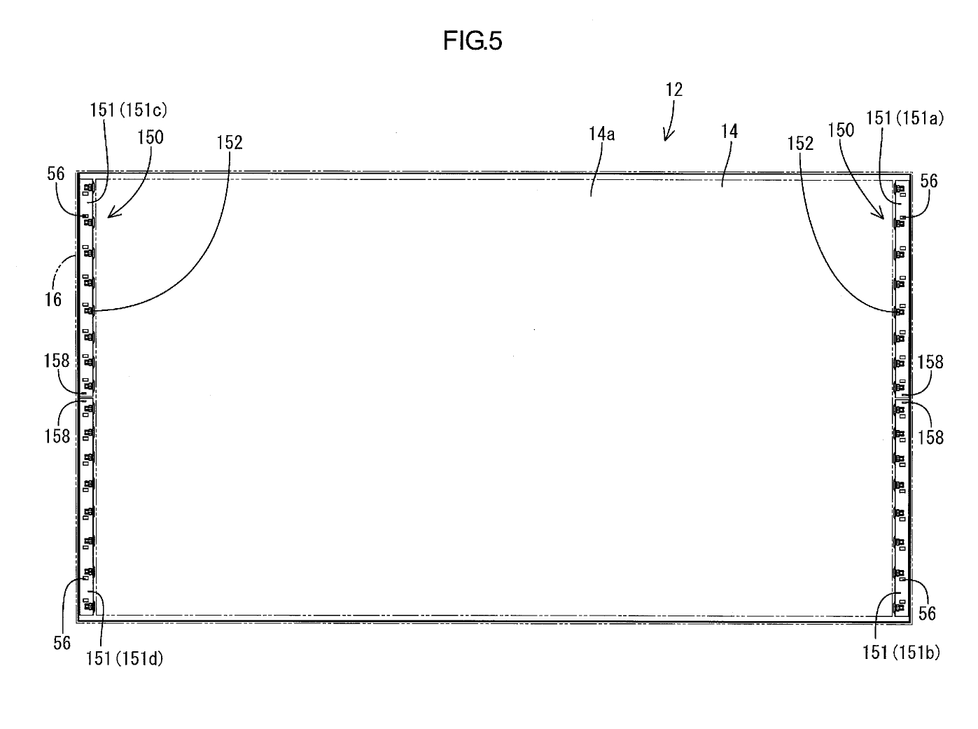

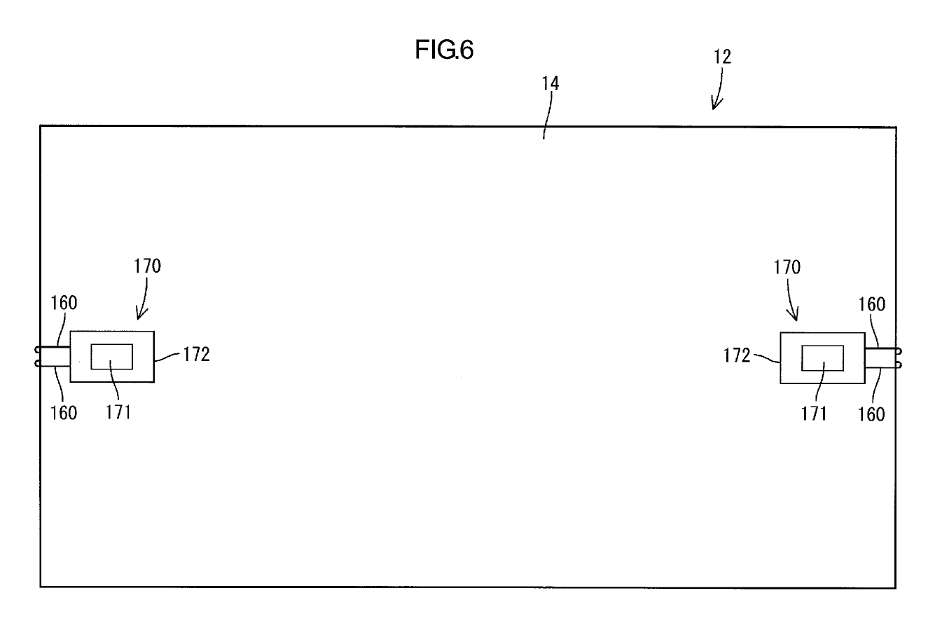

FIG. 1 is an exploded perspective view illustrating a schematic configuration of a television receiver TV of this embodiment. FIG. 2 is an exploded perspective view illustrating a schematic configuration of a liquid crystal display device (a display device) 10 of the television receiver TV. FIG. 3 is a sectional view along line A-A in FIG. 2. FIG. 4 is a front view illustrating a main configuration of a backlight unit 12 of the liquid crystal display device 10. FIG. 5 is a front view illustrating a position of a frame 16 in the backlight unit 12. FIG. 6 is a back view illustrating a main configuration of the backlight unit 12.

FIG. 1 illustrates the television receiver TV of this embodiment. The television receiver TV includes a liquid crystal display device (display device) 10, a front cabinet Ca, a back cabinet Cb, a power source P, a tuner T, and a stand S. The front cabinet Ca and the back cabinet Cb hold the liquid crystal display device 10 therebetween. The power source P is different from below-described power boards 170 (a power source of the present invention). The liquid crystal display device 10 has a landscape rectangular overall shape. As illustrated in FIG. 2, the liquid crystal display device 10 includes a liquid crystal panel 11 and the backlight unit (a lighting device for a display device) 12. The liquid crystal panel 11 is a display panel having a rectangular shape in planar view. The backlight unit 12 is an external light source. The liquid crystal panel 11 and the backlight unit 12 are held in one piece by a bezel 13 and the like.

The liquid crystal panel 11 has a known configuration, having a light transmissive TFT substrate and a light transmissive CF substrate with a predetermined gap therebetween and with liquid crystals (a liquid crystal layer) sealed between the substrates. The optical characteristics of the liquid crystal change according to a voltage applied thereto. The TFT substrate has an inner surface on which source lines and gate lines are arranged. The source line and the gate lines extend in the vertical direction and the horizontal direction, respectively, thereby forming a lattice pattern. The CF substrate has a color filter. The color filter includes color sections in three primary colors of read (R), green (G), and blue (B) in matrix arrangement. Each substrate has a surface opposite from the liquid crystal side. A polarizing plate is attached to the surface.

The backlight unit 12 is a so-called direct backlight unit, having a plurality of light sources directly facing the backside surface of the liquid crystal panel 11. The backlight unit 12 includes a chassis 14, a light reflection sheet 14a, an optical member 15, the frame 16, a plurality of cold cathode tubes 17, and lamp holders 19. The front side (a light-exit side) of the chassis 14 is open. The light reflection sheet 14a is laid in the chassis 14. The optical member 15 is secured to the opening of the chassis 14. The frame 16 holds the optical member 15. The chassis 14 houses the cold cathode tubes 17. The lamp holders 19 block the light emitted from ends of the cold cathode tubes 17. The lamp holders 19 themselves have light reflectivity.

The cold cathode tubes 17 (discharge tubes) are linear light sources each emitting linear light. The optical member 15 converts the linear light to planar light. The optical member 15 also has a function of directing the planar light toward an effective display area of the liquid crystal panel 11 (i.e., directivity).

The chassis 14 is made of metal plate and has a rectangular shape in plan view. The chassis 14 has a substantial box-like shape with the front side (the light-exit side) open. The light reflection sheet 14a is made of synthetic resin. The light reflection sheet 14a is a white member, having a high reflectivity. The light reflection sheet 14a is laid over the substantially entire area of an inner surface of the chassis 14. With the light reflection sheet 14a, most of the light emitted from the cold cathode tubes 17 is guided to the opening side of the chassis 14.

FIGS. 4 and 5 illustrate light-source holders 150 provided in front (on the inner surface side) of the chassis 14. Each light-source holder 150 has clip terminals (connecting terminals) 152. The clip terminals 152 hold the respective ends of the respective cold cathode tubes 17. The clip terminals 152 are configured to supply drive power to the respective cold cathode tubes 17. The light-source holders 150 hold the cold cathode tubes 17 in parallel arrangement on the front side of the chassis 14. In this embodiment, the cold cathode tubes 17 are arranged at irregular intervals. In other words, the interval between the adjacent cold cathode tubes 17 is smaller in an area while is larger in another area. Specifically, the interval is gradually larger from the center in the arrangement direction of the cold cathode tubes 17 toward the outside in the arrangement direction.

FIG. 6 illustrates the power boards 170 (a power source) disposed behind the chassis 14. Because each power board 170 includes an inverter circuit for supplying the drive power to the cold cathode tubes, the power boards 170 can parallel drive the cold cathode tubes 17. In this embodiment, the power boards 170 are provided on respective lateral side portions of the backside of the chassis 14, adopting a double-side driving method to supply power from the power source to respective sides of each cold cathode tube 17. The configuration of supplying the drive power to the cold cathode tubes 17 and its functions will hereinafter be described.

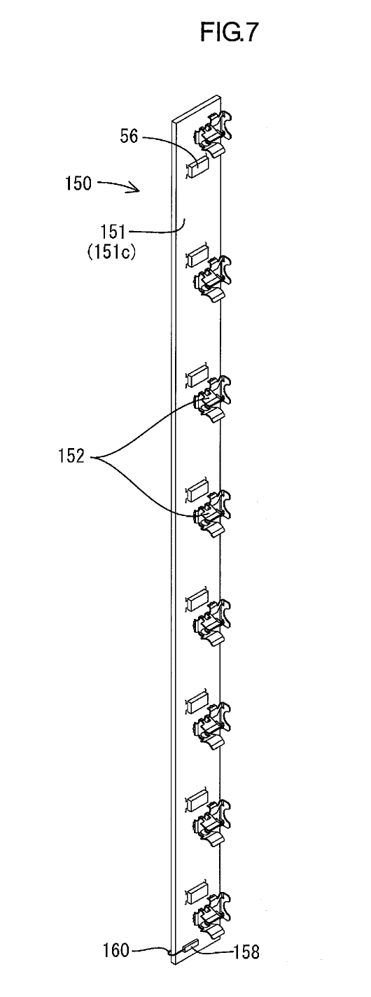

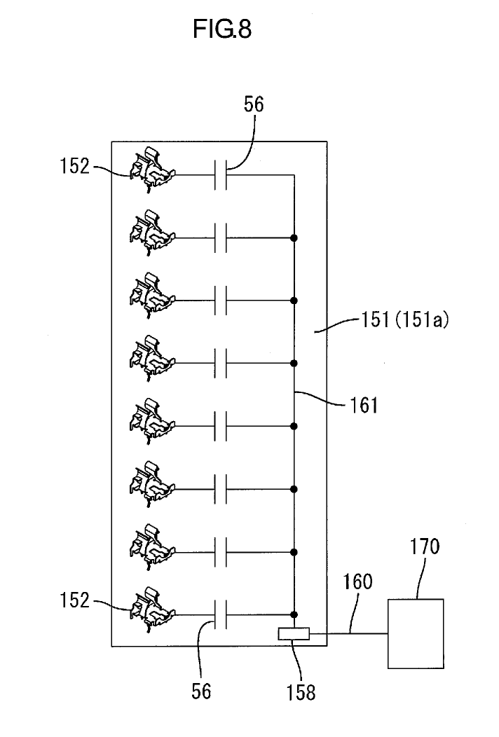

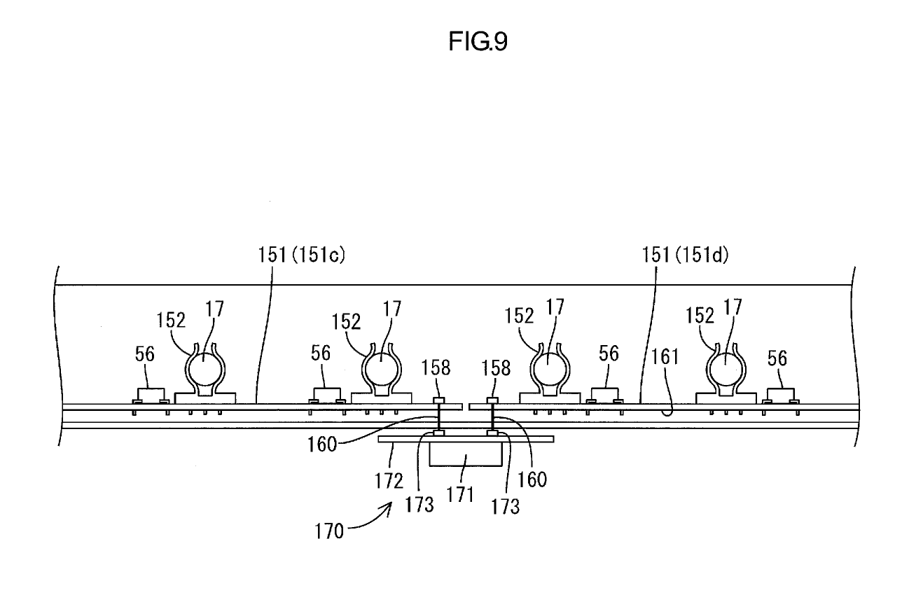

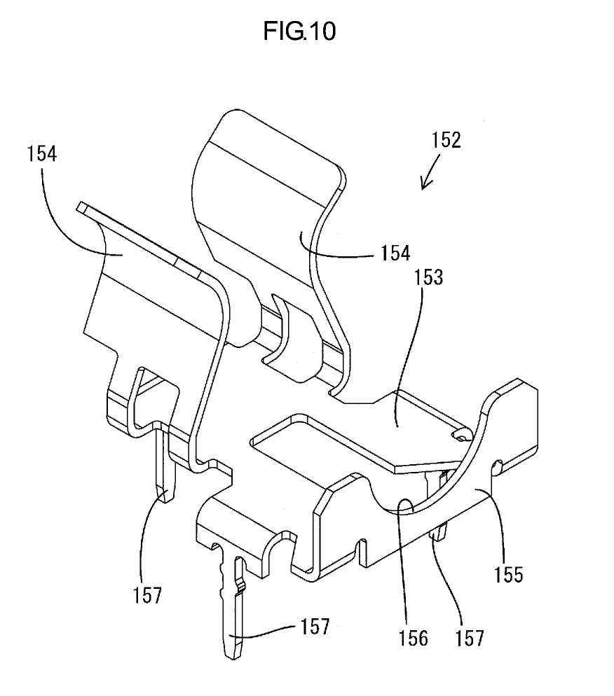

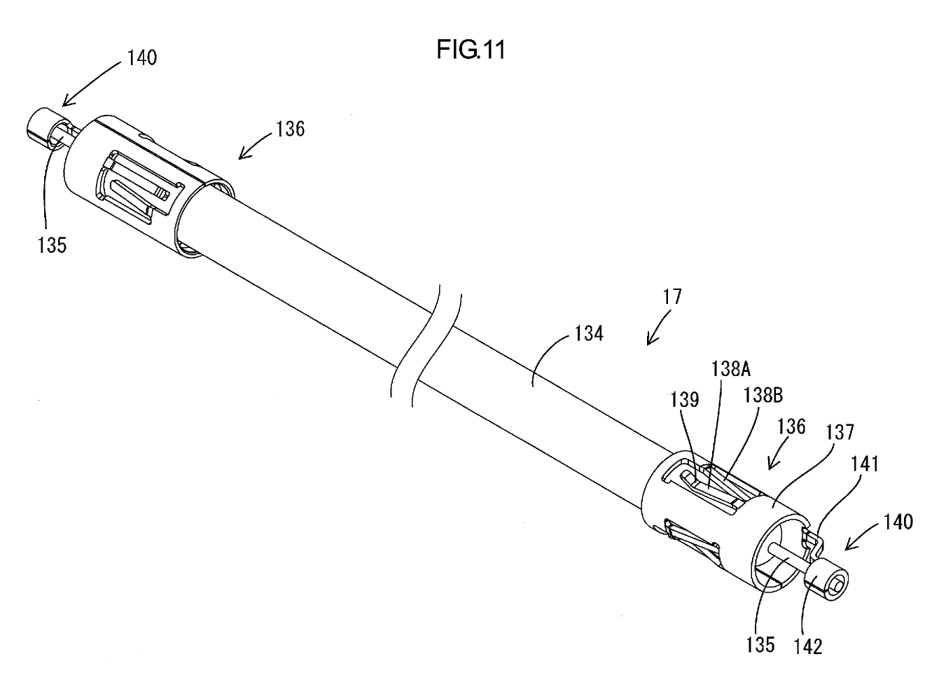

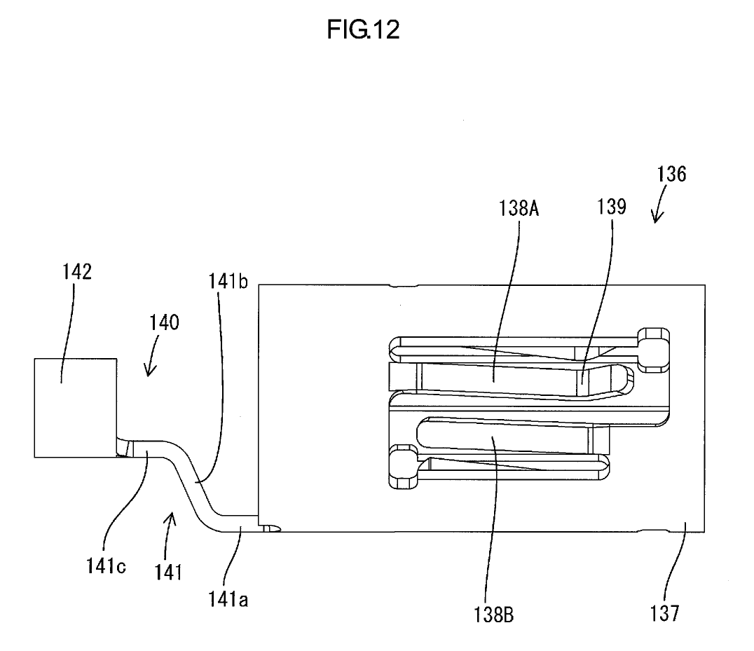

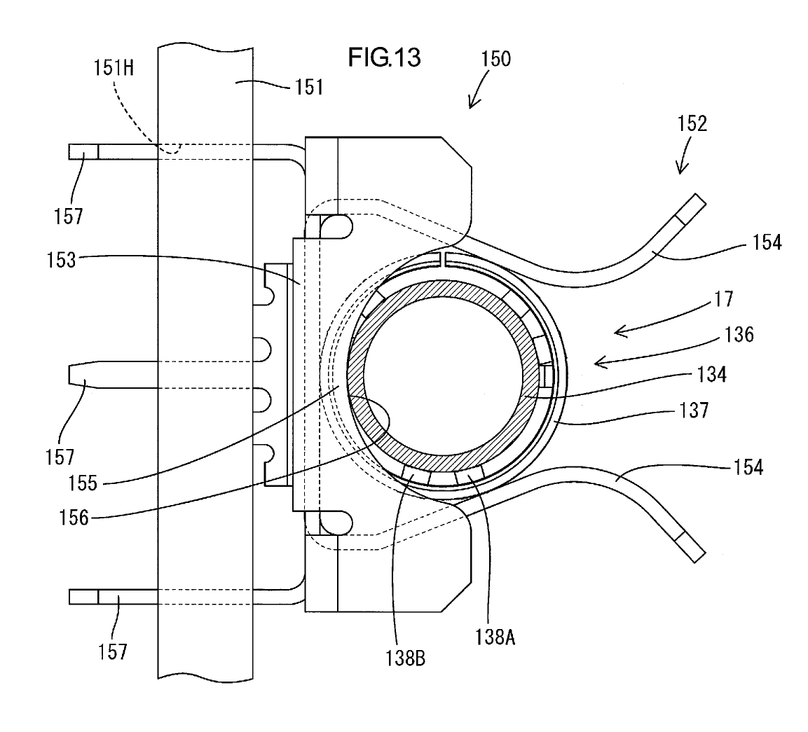

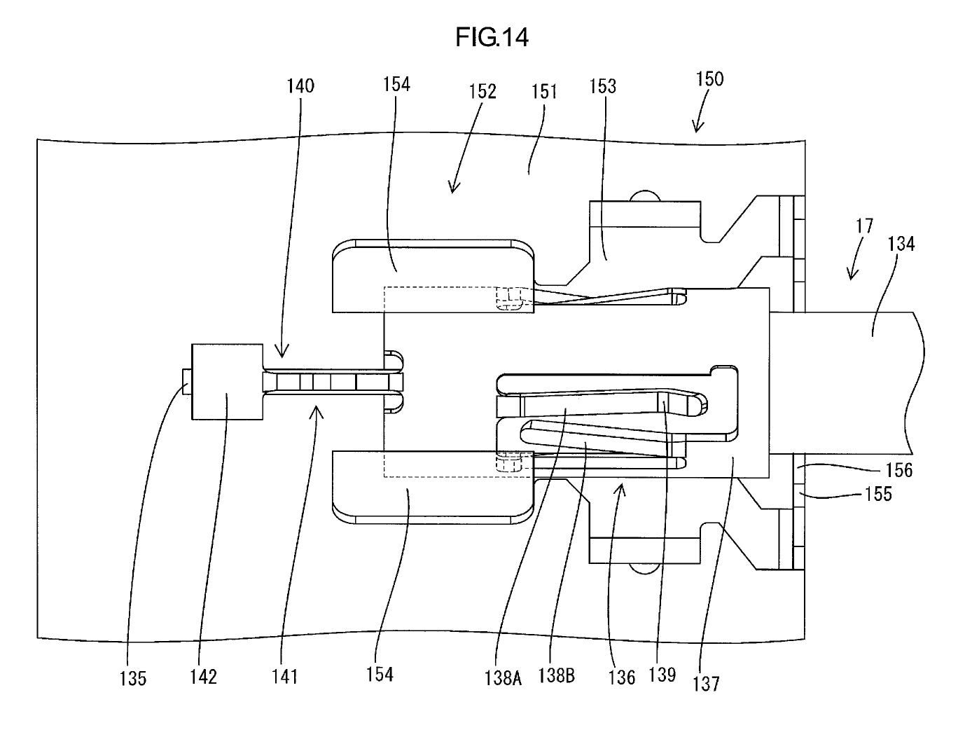

FIG. 7 is a perspective view illustrating a configuration of the light-source holder 150. FIG. 8 is an explanatory diagram illustrating a circuit configuration related to the power supply. FIG. 9 is an explanatory view schematically illustrating a configuration related to the power supply. FIG. 10 is a perspective view illustrating a configuration of one of the clip terminals 152. FIG. 11 is a perspective view illustrating a configuration of one of the cold cathode tubes 17. FIG. 12 is a plan view illustrating a configuration of a ferrule 136 of the cold cathode tube 17. FIG. 13 is a front view illustrating a state in which the clip terminal 152 is holding the cold cathode tube 17. FIG. 14 is a plan view illustrating the state in which the clip terminal 152 is holding the cold cathode tube 17.

Cold Cathode Tube 17

The configuration of the cold cathode tubes 17 will hereinafter be described.

FIG. 11 illustrates one of the cold cathode tubes 11. The cathode tube 17 includes a glass tube 134, outer leads 135, and the ferrules 136. The glass tube 134 has a generally elongated linear shape with a round cross section. Each outer lead 135 extends from a corresponding end of the glass tube 134 linearly and coaxially with the glass tube 134. The outer lead 135 is made from metal (e.g. such as nickel-contained or cobalt-contained metal). The outer lead 135 has an elongated shape with a round cross section. Each ferrule 136 is fitted onto the corresponding end of the glass tube 134. Mercury is sealed in the glass tube 134. Each end of the glass tube 134 has a substantially hemispherical shape, which is formed by hot melting. The outer lead 135 runs through the hemispherical portion.

FIG. 12 illustrates one of the ferrules 136. The ferrule 136 is a one-piece part. A piece of a metal plate (e.g. a stainless steel plate) is cut into a predefined shape and then shaped into the ferrule 136 by bending and hammering. The ferrule 136 includes a single body 137 and a single conductive piece 140. The body 137 has an overall cylindrical shape concentric with the glass tube 134. The body 137 has an inner diameter slightly greater than the outer diameter of the glass tube 134.

The body 137 is partially slit at circumferentially equal intervals, and thereby forming three pairs of elastic holding pieces 138A, 138B.

The first elastic holding piece 138A, which is one of the elastic holding pieces 138A, 138B in each pair, extends generally backward (specifically, slightly radially inward or obliquely) in a cantilever fashion. The first elastic holding piece 138A can radially and elastically bend about a basal end (a front end) thereof as a fulcrum. An extending end portion (a rear end portion) of the first elastic holding piece 138A is turned radially outward or obliquely at a turned portion 139. The turned portion 139 has an outer surface with respect to the turn thereof (i.e. a surface which faces inward). The outer surface of the turned portion 139 is a contact point that abuts on an outer periphery of the glass tube 134. A virtual circle connecting these three first elastic holding pieces 138A is concentric with the body 137. When the first elastic holding pieces 138A are in a free state, that is, when they are not elastically bending, the virtual circle has a diameter smaller than the outer diameter of the glass tube 134.

The second elastic holding piece 138B, which is the other one of the elastic holding pieces 138A, 138B in each pair, is disposed circumferentially adjacent to the corresponding first elastic holding piece 138A. The second elastic holding piece 138B extends generally in a direction opposite from the extending direction of the first elastic holding piece 138A, or frontward (specifically, slightly radially inward or obliquely) in a cantilever fashion. The second elastic holding piece 138B can radially and elastically bend about a basal end (a rear end) thereof as a fulcrum. An extending end of the second elastic holding piece 138B is a contact point that abuts on the outer periphery of the glass tube 134. A virtual circle connecting these three second elastic holding pieces 138B is concentric with the body 137. When the second elastic holding pieces 138B are in a free state, that is, when they are not elastically bending, the virtual circle has a diameter smaller than the outer diameter of the glass tube 134.

The conductive piece 140 extends frontward in a cantilever fashion from an end of the body 137. The conductive piece 140 includes a strip portion 141 and a cylindrical portion 142. The strip portion 141 is continuous with a front end of the body 137. The cylindrical portion 142 extends further frontward from a front end (an extending end) of the strip portion 141. The strip portion 141 includes a basal end portion 141a, a middle portion 141b, and a distal end portion 141c. The basal end portion 141a extends flush with the body 137 and parallel to the axis of the body 137. The middle portion 141b extends radially inward from an extending end of the basal end portion 141a toward the axis of the body 137. The distal end portion 141c extends parallel to the axis of the body 137 from an extending end of the middle portion 141b. The cylindrical portion 142 is continuous with an extending end of the distal end portion 141c. The strip portion 141 has a width sufficiently smaller than a length thereof. Therefore, the strip portion 141 can elastically deform in a radial direction of the body 137, in a direction crossing the radial direction of the body 137 (in a direction crossing the length of the strip portion 141), and torsionally around the axis of the strip portion 141 itself. A portion laterally spreads from the extending end of the strip portion 141. The cylindrical portion 142 is formed by bending this portion into a cylindrical shape with the axis substantially coaxial with the body 137. As the strip portion 141 elastically bends, the cylindrical portion 142 moves in a direction around the axis of the ferrule 136 and in the radial direction of the ferrule 136.

Light-Source Holder 150

FIGS. 4 and 5 illustrates the configuration of the light-source holders 150. FIGS. 4 and 5 are front views of the backlight unit 12, wherein a schematic configuration of the light-source holders 150 is illustrated. In FIG. 5, the cold cathode tubes 17 are not shown.

The light-source holders 150 have a function of holding respective ends of the cold cathode tubes 17 to secure the cold cathode tubes 17 to the chassis 14. The light-source holder 150 includes elongated support plates (support members) 151, the clip terminals 152, and a plurality of ballast capacitors 56. The clip terminals 152 are arranged in line in front of the support plates 151. The ballast capacitors 56 are provided for balancing the currents of the drive power supplied to the respective clip terminals 152.

The support plates 151 include four plates (support plates 151a, 151b, 151c, 151d) made of a conductive material such as metal and disposed on the surface of the chassis 14. Specifically, two of the support plates 151 are secured to each of two lateral side areas on the surface of the chassis 14. Each support plate 151 has three securing holes H formed therethrough for each clip terminal 152 (see FIG. 13). The clip terminals 152 are fitted in the securing holes H.

FIG. 10 illustrates one of the clip terminals 152. A metal (e.g. nickel silver alloy) is cut into a desired shape and then is shaped into the clip terminal 152 by bending. The clip terminal 152 includes a base 153, a pair of elastic pressing pieces 154, and a stopper 155. The elastic pressing pieces 154 are vertically symmetrical. The elastic pressing piece 154 extend frontward from respective upper and lower edge portions of the base 153. The base 153 has two opposed lateral sides. The stopper 155 extends frontward from one of the lateral sides of the base 153.

The elastic pressing pieces 154 are disposed on a side close to the other one of the lateral sides of the base 153. The elastic pressing pieces 154 have a bulged shape with parts thereof curved toward each other. The elastic pressing pieces 154 can elastically bend in a direction to increase the distance therebetween. When the elastic pressing pieces 154 are not elastically bending, the minimum distance between the elastic pressing pieces 154 is smaller than the outer diameter of the glass tube 134 of the cold cathode tube 17.

The stopper 155 upstands from the base 153 perpendicular to the axis of the cold cathode tube 17. The stopper 155 has a recess 156 of a substantially arcuate shape. The stopper 155 has areas upper than and lower than the recess 156. The upstanding measurement of these areas from the base 153 is as small as appropriate so as to reduce the metal material needed for the clip terminal 152.

Three legs 157 and the base 153 are formed in one piece. Two of the legs 157 protrude from the upper and lower edges of the base 153 between the elastic pressing pieces 154 and the stopper 155 backward. In other words, the leg 157 extends in a direction opposite from the extending direction of the elastic pressing pieces 154 and the stopper 155. While the stopper 155 extends from the lateral side of the base 153 as described above, the other one of the legs 157 protrudes from a middle portion of a backside of the lateral side of the base 153 backward, that is, in a direction opposite from the extending direction of the elastic pressing pieces 154 and the stopper 155.

The clip terminals 152 are not covered by a housing or any other member made of synthetic resin. The bare clip terminals 152 are secured to the support plate 151 by soldering with the legs 157 being passed through respective securing holes 151H in the support plate 151.

The ballast capacitors 56 are balancing components and are provided corresponding to the respective clip terminals 152. All clip terminals 152 are provided with the respective ballast capacitors 56. The ballast capacitors 56 are connected in series to the respective clip terminals 152 (see FIG. 8). The ballast capacitors 56 are disposed adjacent to the respective clip terminals 152 and in an area on the support plate 151. The area is closer to the center in the arrangement direction of the cold cathode tubes 17 than outermost one of the clip terminal 152 in the arrangement direction (see FIG. 4).

FIGS. 4 and 5 illustrates the configuration more specifically. Namely, one of the clip terminals 152 is disposed outermost in the arrangement direction of the cold cathode tubes 17 on the support plate 151. One of the ballast capacitors (an outermost balancing component) 56 is provided corresponding to the outermost clip terminal 152. The one of the ballast capacitor 56 is disposed adjacent to the outermost clip terminal 152 and closer to the center in the arrangement direction of the cold cathode tubes 17 than the outermost clip terminal 152. The ballast capacitors 56 corresponding to the other clip terminals 152 are disposed adjacent to the respective clip terminals 152 and outer in the arrangement direction of the cold cathode tubes 17 than the respective clip terminals 152.

The above will be described in other words, referring to FIGS. 4 and 7 again. FIG. 4 illustrates the support plate 151c disposed on an upper left side portion of the chassis 14. FIG. 7 illustrates the configuration on the support plate 151c. Namely, one of the clip terminals 152 is disposed outermost in the arrangement direction of the cold cathode tubes 17 on the support plate 151c. Another one of the clip terminals 152 is disposed adjacent to the outermost clip terminal 152 and closer to the center in the arrangement direction of the cold cathode tubes 17 than the outermost clip terminal 152. There is an area between these two clip terminals 152. That is, two of the cold cathode tubes 17 are arranged adjacent to each other and at a largest interval therebetween. Two of the clip terminals 152 hold these two cold cathode tubes 17. There is an area between these two clip terminals. In this area, two of the ballast capacitors 56 corresponding to the two of the clip terminals 152 are disposed. There are areas between the other clip terminals 152. In each of these areas, one of the ballast capacitors 56 (one of the ballast capacitors 56 corresponding to the clip terminals 152 closer to the center) is disposed.

FIG. 7 illustrates the single support plate 151c. The other support plates 151a, 151b, and 151d have similar configurations. Specifically, one of the clip terminals 152 is adjacent to the outermost clip terminal 152 in the arrangement direction of the cold cathode tubes 17. There is an area between these two clip terminals. In this area, two of the ballast capacitors 56 are disposed. There are areas between the other clip terminals 152. In each of these areas, one of the ballast capacitors 56 is disposed. As illustrated in FIGS. 4 and 5, the two support plates 151a and 151b are vertically arranged on a right side portion of the chassis 14. The arrangement of the clip terminals 152 and the ballast capacitors 56 on the support plates 151a, 151b are symmetrical with respect to a boundary line between the support plates 151a and 151b. Similar to the above, the two support plates 151c, 151d are vertically arranged on a left side portion of the chassis 14. The arrangement of the clip terminals 152 and the ballast capacitors 56 on the support plates 151c, 151d is symmetrical with respect to a boundary line between the support plates 151c and 151d.

The support plates 151a, 151b is disposed on the right side portion of the chassis 14. Two of the cold cathode tubes 17 are arranged adjacent to each other and the closest to the center in the arrangement direction. Two of the clip terminals 152 on the support plates 151a, 151b support the two of the cold cathode tubes 17. In other words, two of the clip terminals 152 are disposed closer in the arrangement direction of the cold cathode tubes 17 on the center end portions of the respective support plates 151a, 151b. No ballast capacitor 56 is disposed between the two of the clip terminals 152. The configuration on the pair of support plates 151c, 151d on the left side portion of the chassis 14 is similar to the above. Specifically, two of the cold cathode tubes 17 are arranged adjacent to each other and the closest to the center in the arrangement direction. Two of the clip terminals 152 on the support plates 151c, 151d support the two of the cold cathode tubes 17. No ballast capacitor 56 is disposed between the two of the clip terminals 152.

These ballast capacitors 56 are connected in parallel to the power board (the power source) 170. More specifically, the ballast capacitors 56 are connected to a common line 161 as illustrated in FIGS. 8 and 9. The common line 161 is provided on the back surface of each support plate 151. Through the common line 161, the ballast capacitors 56 are connected to a power-source connecting connector (a power-source connector) 158. The power-source connecting connector 158 is provided on the center end portion of each support plate 151. The power-source connecting connectors 158 are connected to respective power supply lines 160. The power supply lines 160 are connected to the power board 170.

FIGS. 4 and 5 illustrates the arrangement of the power-source connecting connectors 158 of this embodiment. Specifically, one of the power-source connecting connector 158 is disposed on the center end portion of each of the support plates 151a, 151b, 151c, 151d. One of the clip terminals 152 is disposed the closest to the center in the arrangement direction of the cold cathode tubes 17. The power-source connecting connector 158 is disposed still closer to the center than the clip terminal 152.

Power Board 170

FIG. 9 illustrates one of the power boards 170. Specifically, the power board 170 includes a circuit board 172, an electronic components 171, and board connectors 173. A circuit is formed on a back surface (a surface opposite from the chassis 14) of the circuit board 172. The electronic components 171 are mounted to the back surface of the circuit board 172. The circuit board 172 has a surface closer to the chassis 14. The board connectors 173 are secured to the surface of the circuit board 172. The electronic components 171 include a transformer and other components. With these components, the circuit board 172 is configured as an inverter board that generates a high-frequency voltage. Each board connector 173 is connected to the corresponding power-source connecting connector 158 via the corresponding power supply line 160. Each power-source connecting connector 158 is provided on the corresponding support plate 151 in the chassis 14, as described above. The power board 170 is secured to the chassis 14 by screwing etc.

Attachment of Cold Cathode tube 17 to Clip Terminal 152

The manner of attaching each cold cathode tube 17 to the corresponding clip terminal 152 will now be described. The cold cathode tube 17 is held in the horizontal position and brought to the front of the chassis 14. Next, each end portion of the glass tube 134 and the ferrule 136 are forced into the space in the corresponding opposing pair of elastic pressing pieces 154 from the front (see FIGS. 13 and 14). The body 137 of the ferrule 136 then elastically bends the elastic pressing pieces 154 to open them. After the body 137 passes the narrowest space between the elastic pressing pieces 154, the elastic pressing pieces 154 forces the body 137 toward the base 153 by their elastically returning force until the body 137 comes into contact with the base 153. Thus, attachment of the cold cathode tube 17 is finished.

The cold cathode tube 17 in the attached state is supported at the ends thereof by the clip terminals 152. Because the pair of elastic pressing pieces 154 elastically contact the outer periphery of the body 137 of the corresponding ferrule 136, the outer lead 135 is conductively connected to the clip terminal 152 via the ferrule 136. Furthermore, the glass tube 134 is held against a wall of the recess 156 of the stopper 155 by the elastically returning force of the pair of elastic pressing pieces 154. Therefore, as viewed in the axial direction of the cold cathode tube 17, the body 137 partially overlaps the stopper 155. In other words, the end of the body 137 opposite from the conductive piece 140 is partially opposed to the stopper 155 with a little axial distance therebetween.

As described above, the television receiver TV of this embodiment includes the liquid crystal display device 10, which has the backlight unit 12 according to the present invention. The operational functions of this configuration will now be described.

The ballast capacitors 56 are connected between the respective clip terminals 152 and the power board 170 to balance the currents of the drive power to be supplied to the clip terminals 152. Because of this, the currents fed to the respective cold cathode tubes 17 are balanced (evened). Therefore, the common power board 170 can parallel drive the plurality of cold cathode tubes 17.

Furthermore, in this embodiment, the cold cathode tubes 17 are arranged at irregular intervals. In other words, the intervals between the cold cathode tubes 17 in an outer area in the arrangement direction of the cold cathode tubes 17 are larger. Therefore, the backlight unit 12 requires less number of cold cathode tubes 17. This contributes to cost reduction.

Furthermore, the ballast capacitors 56 are disposed in an area and adjacent to the respective clip terminals 152. The area is closer to the center than the outermost clip terminal 152 on the same support plate 151 in the arrangement direction of the cold cathode tubes 17. In comparison to this configuration, another configuration can be considered. In the configuration, a ballast capacitor is disposed still outer than an outermost clip terminal in an arrangement direction of cold cathode tubes. When being compared to this configuration, the configuration of this embodiment provides a narrower frame area, which is a non-illumination area of the backlight unit 12.

In other words, if a ballast capacitor is disposed outer than a clip terminal that holds an outermost cold cathode tube, the quantity of light in the area in which the ballast capacitor is disposed is not enough. Accordingly, this area is a non-illumination area (the frame area) that is outside of an effective display area.

On contrary to this, according to this embodiment, no ballast capacitor 56 is disposed outer than the clip terminal 152 that holds the outermost cold cathode tubes 17. Accordingly, as illustrated in FIG. 5, the non-display area in the backlight unit 12, which is covered by the frame 16, is narrower.

Because of this, the frame area of the backlight unit 12 is narrower. Therefore, the frame area of the liquid crystal display device 10 is narrower.

Furthermore, in this embodiment, one of the clip terminals 152 is disposed outermost on the support plate 151c in the arrangement direction of the cold cathode tubes 17. Another clip terminal 152 is disposed adjacent to the outermost clip terminal 152 and closer to the center in the arrangement direction of the cold cathode tubes 17 than the outermost clip terminal 152. There is an area between these two clip terminals 152. In other words, two of the cold cathode tubes 17 are arranged adjacent to each other and at a largest interval. Two of the clip terminals 152 hold these two cold cathode tubes 17. There is the area between these two clip terminals. Two of the ballast capacitors 56 corresponding to the two of the clip terminals 152 are disposed in this area. Because of this, no ballast capacitor 56 is not disposed between the clip terminals 152 in the center area on the support plate 151 where the cold cathode tubes 17 are arranged at smaller intervals. Therefore, the power-source connecting connector 158 can be disposed in a center area of the power-source connecting connector 158. Furthermore, according to this configuration, there is an area closer to the center in the arrangement direction. The cold cathode tubes 17 in the area are arranged at relatively small intervals. According to the configuration of this embodiment, the intervals between the cold cathode tubes 17 are still smaller in this area.

According to this embodiment, one of the clip terminals 152 is disposed the closest to the center in the arrangement direction of the cold cathode tubes 17. The power-source connecting connector 158 is disposed on the support plate 151 and still closer to the center than the clip terminal 152. In comparison to this configuration, another configuration can be considered such that a power-source connecting connector is disposed outer than a clip terminal holding outermost one of cold cathode tubes. When being compared to this configuration, the configuration of this embodiment provides a narrower frame area, which is the non-illumination area in the backlight unit 12. Therefore, the liquid crystal display device 10 can be provided with the narrower frame area.

### Other Embodiments

The present invention is not limited to the above embodiment. For example, the following configurations may be included in the technical scope of the present invention.

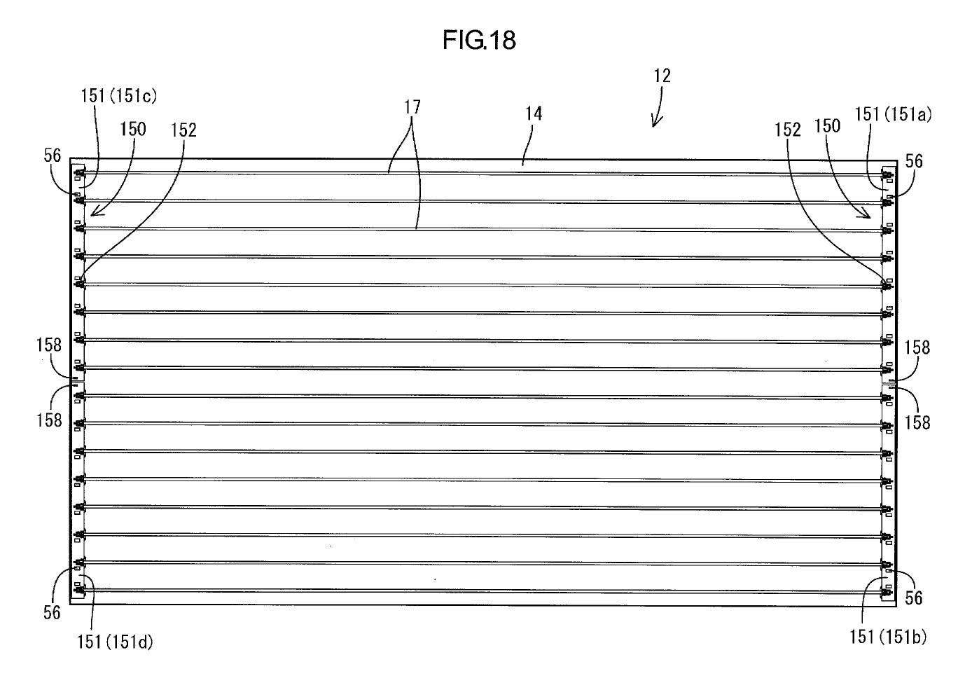

In the above-described embodiment, the cold cathode tubes 17 are arranged at irregular intervals. In other words, the interval between adjacent two cold cathode tubes 17 is smaller in an area and is larger in another area. Instead of this, all of the cold cathode tubes 17 may be arranged at equal intervals as illustrated in FIG. 18. In this case, similar to the above-described embodiment, one of the clip terminals 152 is adjacent to the outermost clip terminal 152 in the arrangement direction of the cold cathode tubes 17. There is an area between these two clip terminals 152. Two of the ballast capacitors 56 are disposed in the area. Because of this, no ballast capacitor 56 is disposed between the clip terminals 152 in the center area on the support plate 151. Therefore, the power-source connecting connector 158 can be disposed in the center area on the support plate 151.

In the above-described embodiment, one of the clip terminal 152 is disposed the closest to the center in the arrangement direction of the cold cathode tubes 17 on each support plate 151. The power-source connecting connector 158 is disposed still closer to the center than the clip terminal 152. The position of the power-source connecting connector 158 on each support plate 151 is not limited to this. The power-source connecting connector 158 can be disposed in any position on the support plate 151 insofar as the position is closer to the center than the outermost clip terminal 152 in the arrangement direction of the cold cathode tubes 17.

In the above-described embodiment, the ballast capacitors 56 are used as the balancing components. Instead of this, balance coils each having respective primary coils and secondary coils may be used. In this case, the primary coil of each balance coil is connected in series to the corresponding clip terminal 152 and in parallel with each other to the power board 170, while the secondary coils of all balance coils are connected in series to one another.

In the above-described embodiment, the parallel driven light source is the cold cathode tubes. The light source is not limited to this. For example, the light source may be hot cathode tubes.

In the above-described embodiment, two separate support plates 151 of the support plates 151a, 151b, 151c, and 151d are arranged in each side area of the chassis 14. However, a single support plate 151 may be provided on each side area of the chassis 14.

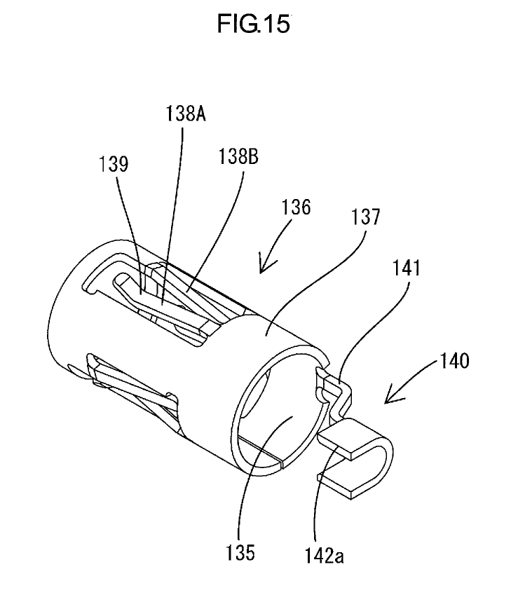

The ferrule may have a configuration illustrated in FIG. 15. Specifically, the cylindrical portion 142 of each ferrule 136 illustrated in FIGS. 11 and 12 may be replaced with a U-shaped cylindrical portion 142a. In this case, after the glass tube 134 is fitted in the ferrule 136, the U-shaped cylindrical portion 142a is bent along the outer lead 135, thereby electrically connecting the outer lead 135 and the cylindrical portion 142a. By bending the U-shaped cylindrical portion 142a, the electrical connection to the outer lead 135 can be still more improved.

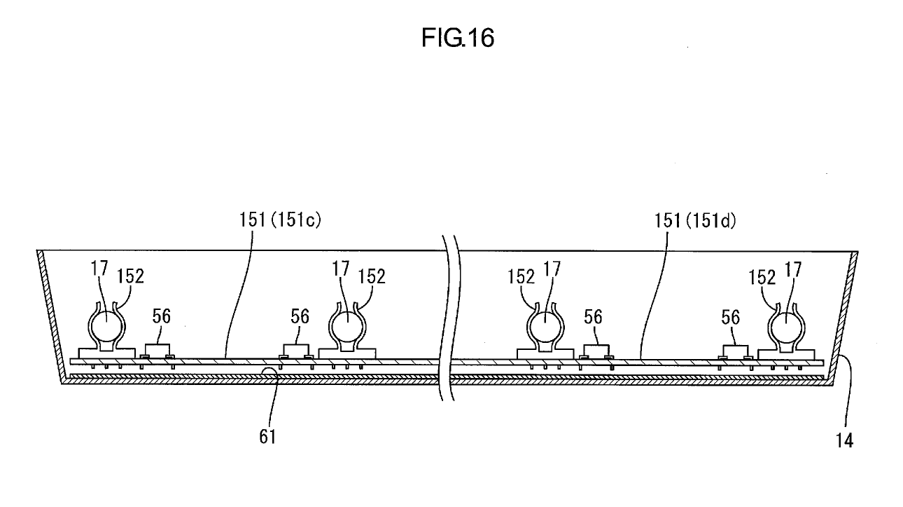

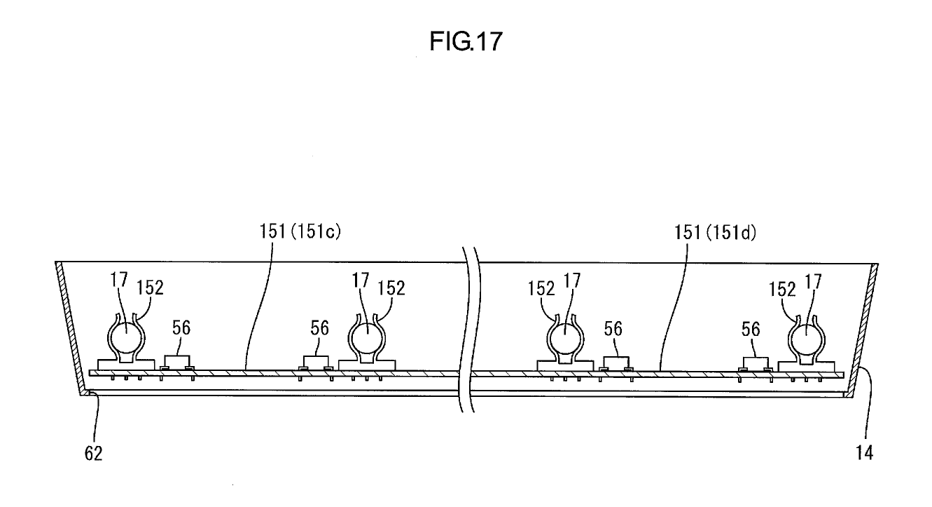

To provide insulation between the chassis 14 and the support plate 151, an insulating board (an insulating member) 61 may be disposed between the chassis 14 and the support plate 151 as illustrated in FIG. 16. Alternatively, the chassis 14 may have an opening 62 in a portion covered by the support plate 151 as illustrated in FIG. 17. Alternatively, the chassis 14 may be made of a resinous material.

The switching components of the liquid crystal panel 11 in the liquid crystal display device 10 are not limited to the TFTs. The switching components may be MIMs (metal insulator metals). Moreover, the display device according to the present invention is not limited to the liquid crystal display device. The display device includes various display devices that need lighting devices behind the display panels.

1. A lighting device for a display device comprising:
a plurality of discharge tubes disposed adjacent to each other in parallel arrangement at predetermined intervals;
a power source configured to supply drive power for parallel driving the discharge tubes;
a support member supporting ends of the discharge tubes;
a plurality of connecting terminals arranged on the support member so as to make an array extending in an arrangement direction in which the discharge tubes are disposed, the connecting terminals holding the discharge tubes individually and configured to function as terminals to supply the drive power to the respective discharge tubes; and
a plurality of balancing components configured to balance currents of the drive power to be fed to the connecting terminals, the balancing components being connected between the power source and the respective connecting terminals,
the plurality of balancing components being disposed adjacent to the respective connecting terminals in an area on the support member, the area being closer to the center in the arrangement direction than outermost one of the connecting terminals in the arrangement direction, and
two of the balancing components being disposed in at least one of areas on the support member, each of the areas being between adjacent two of the connecting terminals in the array, the two of the balancing components corresponding to the two of the connecting terminals.

2. The lighting device for a display device according to claim 1, wherein:
the predetermined intervals include at least two different sizes of intervals;
two of the discharge tubes are arranged at one of the predetermined intervals,
the one of the predetermined intervals being larger than a smallest one of the predetermined intervals;
two of the connecting terminals hold the two of the discharge tubes; and
two balancing components corresponding to the two of the connecting terminals are disposed in an area between the two of the connecting terminals.

3. The lighting device for a display device according to claim 1, wherein:
one of the connecting terminal is adjacent to the outermost connecting terminal in the arrangement direction and closer in the arrangement direction than the outermost connecting terminal in the array;
two of the balancing components correspond to the one of the connecting terminal and the outermost connecting terminal; and
the two of the balancing components are disposed in an area between the one of the connecting terminals and the outermost connecting terminal.

4. The lighting device for a display device according to claim 1, wherein:
the balancing components include an outermost balancing component corresponding to the outermost connecting terminal in the arrangement direction, the outermost balancing component being disposed adjacent to the outermost connecting terminal and closer to the center in the arrangement direction than the outermost connecting terminal; and
other balancing components excluding the outermost balancing component are disposed adjacent to the respective connecting terminals and outer in the arrangement direction than the respective connecting terminals.

5. The lighting device for a display device according to claim 1 further comprising a power-source connector connected to the balancing components and to the power source for supplying the drive power, the power-source connector being disposed on the support member and closer to the center in the arrangement direction than the outermost connecting terminal in the arrangement direction.

6. The lighting device for a display device according to claim 5, wherein:
one of the connecting terminals is disposed the closest to the center in the arrangement direction; and
the power-source connector is disposed on the support member and closer to the center in the arrangement direction than the one of the connecting terminals.

7. The lighting device for a display device according to claim 6 further comprising a chassis housing the discharge tubes and an insulating member, wherein:
the support member is disposed inside the chassis;
the balancing components and the connecting terminals holding the discharge tubes are disposed on a surface of the support member opposite from the chassis;
the power source is disposed outside the chassis; and
the insulating member is disposed between the chassis and the support member.

8. The lighting device for a display device according to claim 1 further comprising a chassis housing the discharge tubes, wherein:
the support member is disposed inside the chassis;
the balancing components and the connecting terminals holding the discharge tubes are disposed on a surface of the support member opposite from the chassis;
the power source is disposed outside the chassis; and
the chassis has a portion covered by the support member, the portion having an opening.

9. The lighting device for a display device according to claim 1 further comprising a chassis made of resin, the chassis housing the discharge tubes, wherein:
the support member is disposed inside the chassis;
the balancing components and the connecting terminals holding the discharge tubes are disposed on a surface of the support member opposite from the chassis; and
the power source is disposed outside the chassis.

10. The lighting device for a display device according to claim 1 further comprising ferrules at ends of the respective discharge tubes, the ferrules being electrically connected to the respective connecting terminals.

11. The lighting device for a display device according to claim 1, wherein the discharge tubes are cold cathode tubes.

12. The lighting device for a display device according to claim 1, wherein the balancing components are capacitors.

13. The lighting device for a display device according to claim 1, wherein the power source includes an inverter circuit configured to generate a high-frequency voltage.

14. A display device comprising:
the lighting device for a display device according to claim 1; and
a display panel configured to provide display using light from the lighting device for a display device.

15. The display device according to claim 14, wherein the display panel is a liquid crystal panel with liquid crystals.

16. A television receiver comprising the display device according to claim 14.
